(19) United States
(12) Patent Application Publication
(10) Pub. No.: US 2023/0128147 A1
(43) Pub. Date: Apr. 27, 2023

(54) Method for Curation and Transaction

(71) Applicant: Alexander Asher Newton, London (GB)

(72) Inventor: Alexander Asher Newton, London (GB)

(21) Appl. No.: 18/049,581

(22) Filed: Oct. 25, 2022

Related U.S. Application Data
(60) Provisional application No. 63/271,603, filed on Oct. 25, 2021.

(51) Int. Cl. G06Q 30/06; G06Q 20/36; G06F 3/0488

(52) U.S. Cl. CPC G06Q 30/0635; G06Q 30/0643; G06Q 20/3678; G06F 3/0488; G06Q 2220/00

(57) ABSTRACT

A method for curation and transaction of goods. The user is presented with a list of goods to browse on an electronic device. The user may opt to keep the goods by swiping right to place it into a bucket, discarding the goods by swiping left, or the user may opt to purchase the good by swiping up. The user may edit the list of saved goods by repeating the same method. The user swipes left to discard the good out of the bucket, may swipe up to purchase the good, or may swipe right to keep the good contained within the bucket. Multiple users can link their accounts so that an action performed by one user, whether to swipe left, swipe right, or swipe up, is reflected across the account of all linked users. Swipes can also initiate rewards.

### FIELD OF THE INVENTION

The present invention relates generally to a method of sorting through and/or purchasing items, commodities, non-fungible tokens (NFT), cryptocurrencies, tokens, artwork, content, physical objects, digital objects, property, products, images, video, movies, services, or material (herein referred to generally as goods, content, products, and/or items). More specifically, the present invention is a method for a user to curate goods that comprises sorting through and re-sorting through the goods with the use of swiping, dragging, or tapping a button, and collecting preferable goods into an editable saved list, or basket where a transaction can be finalized, or even combinations of both modes tailored to the needs of the end user, while enabling the platform to reward creators with tokens and/or currency for being curated.

### BACKGROUND OF THE INVENTION

The internet has grown exponentially over the years and goods have become widely produced alongside the growth of the internet. Goods are produced across a variety of platforms, genres, mediums, and industries. The creators want their goods to be noticed and the curators want to see preferred goods. These goods can include those available for purchase or collection as well, meaning the curators want to be viewing goods that are especially appealing to said curators during their search. Typical lists of content amass copious amounts of data and configure the data into categories with a variety of traits. This large amount of data is difficult for curators to sort through. When one finds something appealing, one may bookmark the item in a browser or notepad or send an email or text message to oneself to save the content for another time. This places a burden on one to traverse multiple applications and platforms simply to save appealing content. Additionally, decisions to collect or purchase digital content or products available online are not always made in the moment such content or products are discovered. Comparison between such content or products is often done over a span of hours or even days prior to one making a decision.

It is an objective of the present invention to provide one with a method of augmenting the decision-making process for curators. The method can be applied to a multitude of industry applications such as discovering and sorting investment opportunities, discovering art, or deciding upon which movie or television show to watch. And because such a tool has the potential to greatly benefit the end user's ability to curate, it can be paired with a subscription model, either premium (for a currency fee) or freemium (containing ads), that fuels rewards for creators at a revenue split decided upon by the platform. In addition, due to the advancements in blockchain technology, it has become possible to fractionalize ownership of goods with the use of tokens. A non-fungible token can be wrapped in fungible tokens. I.e., one property represented as a non-fungible token can have its entire value, or even a portion of it be represented by a supply of fungible tokens. Those fungible tokens may have control over the property and be entitled to proceeds from that property's monetization. It is also an objective of the present invention to enable curators (if they and the creator both wish) to initiate the trade of tokens/or currency for fungible tokens that represent non-fungible tokens, at a level that can be decided upon by the user. For example, user (a) could choose to initiate the purchase of five tokens worth of an item with an action of the invention, and user (b) could choose to initiate the purchase of 20 tokens worth of an item with an action of the invention.

### SUMMARY OF THE INVENTION

The present invention is a multi-step method for users to curate goods that consists of sorting through goods by swiping and allotting preferable goods into an editable saved list where only the sorted and curated goods reside, while not allowing unwanted goods into the editable saved list. The saved list can then be edited with another round of curation known as Re-swipe. Buttons can also be used to enable the cards showcasing the goods to move in a multitude of different directions representing the action the user wishes to perform with the application. The method also provides a curator a way to initiate a variety of financial transaction processes every time a piece of content is allotted into the bucket. Such financial transactions can be outright purchases, partial purchases of goods, or initiation of platform rewards in the form of tokens, cryptocurrency, fiat currency, points, or valuables for goods creators.

### BRIEF DESCRIPTION OF THE DRAWINGS

FIG. 1 is a view of the steps of the present invention.

FIG. 2 is a view of the initial curation screen of the present invention.

FIG. 3 is a view of the Re-swipe process of the present invention.

FIG. 4 is a view of the checkout page of the present invention.

FIG. 5 is a view of editing the purchase amount on items of the present invention.

FIG. 6 is a view of a collaborative feature of the present invention.

FIG. 7 is a view of the token reward system of the present invention.

FIG. 8 is a flowchart of the method of the present invention.

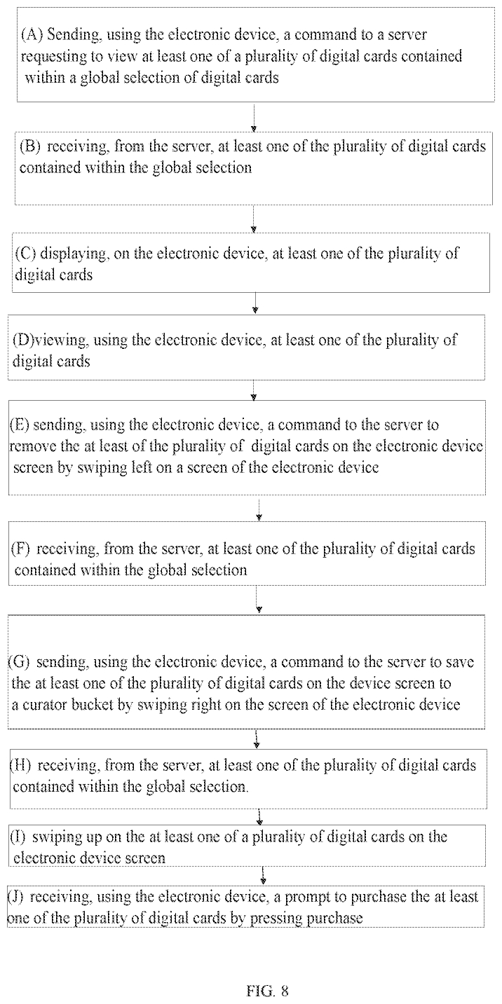

FIG. 9 is a flowchart of the method of the present invention.

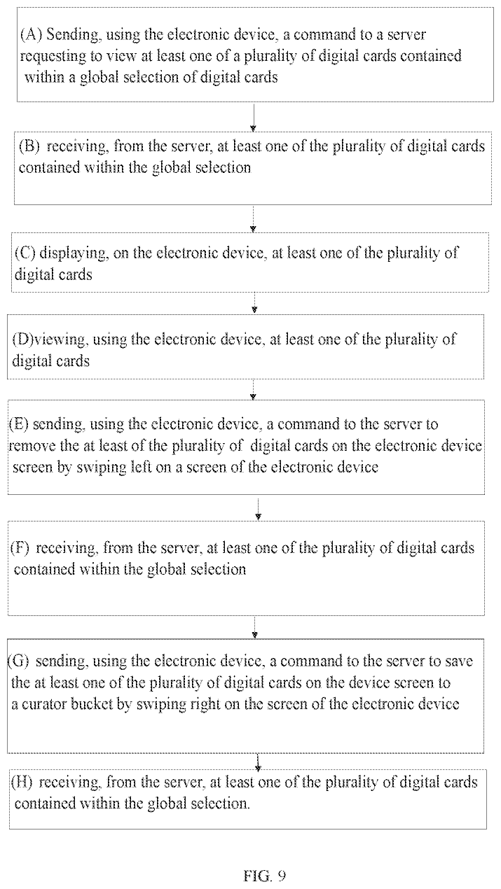

FIG. 10 is a flowchart of the method of the present invention.

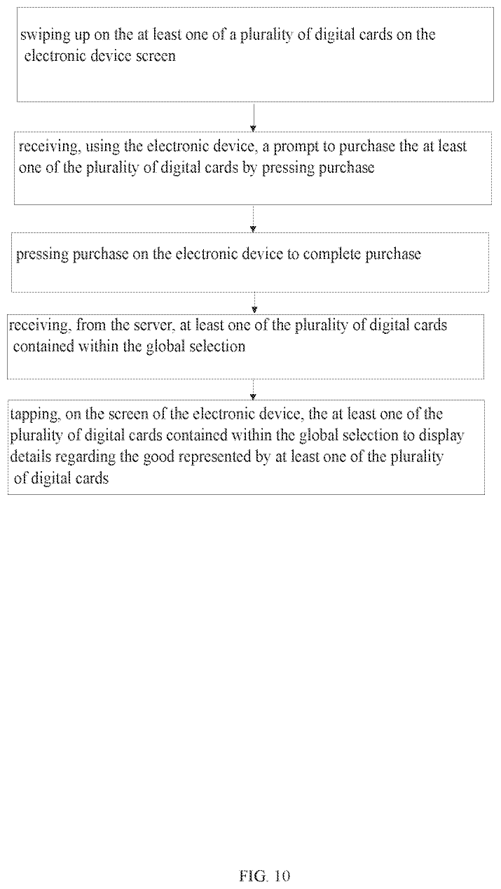

FIG. 11 is a flowchart of the method of the present invention.

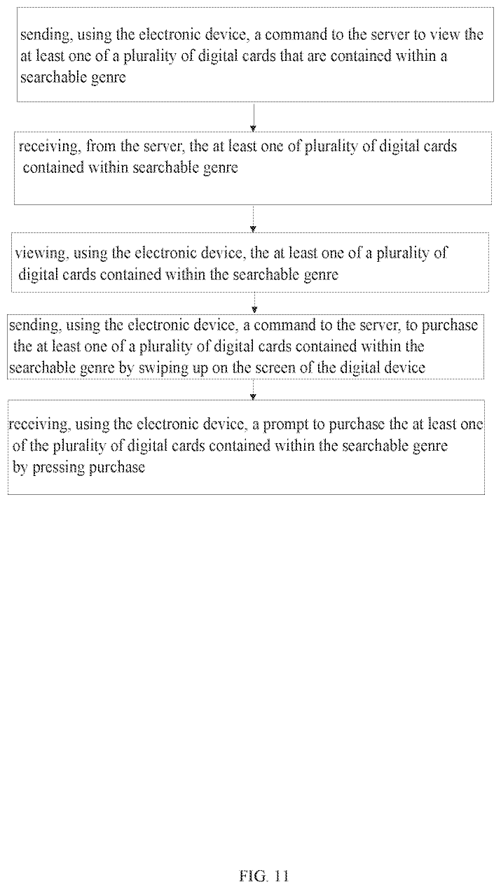

FIG. 12 is a flowchart of the method of the present invention.

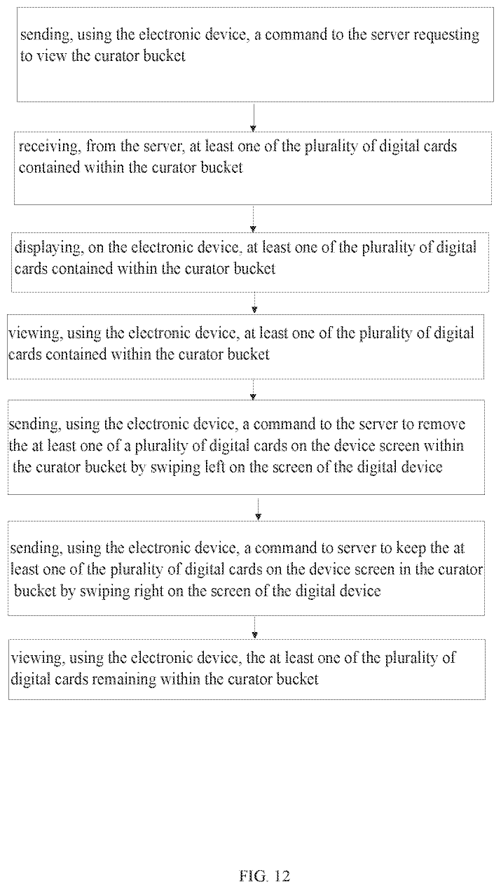

### DETAIL DESCRIPTIONS OF THE INVENTION

All illustrations of the drawings are for the purpose of describing selected versions of the present invention and are not intended to limit the scope of the present invention.

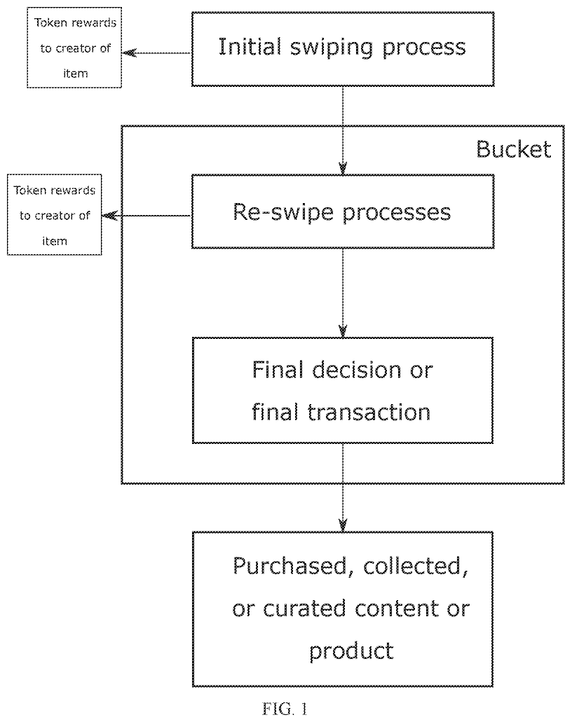

In reference to FIG. 1 through FIG. 7, the present invention is a method for curation and transaction. The present invention attempts to provide one with a means for sorting content or other items effectively and efficiently. The overall method followed by the present invention is shown in FIG. 1.

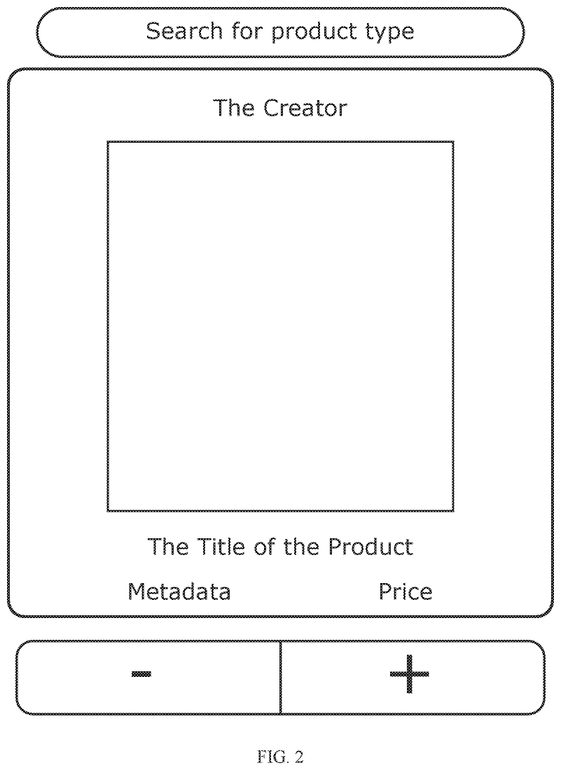

In a preferred embodiment, the method for curation and transaction comprises a digital plurality of cards on an electronic device operated by touch screen, touch pad, mouse, or any type of device controller, or in a 3D space such as in a game engine. For example, within a genre surrounding art, one would only see metadata and images for art. Each of the plurality of digital cards shown represents a product able to be purchased. The layout of an individual card can be seen in FIG. 2. The plurality of digital cards are stored within the server of the platform and one can view the plurality of digital cards by entering the appropriate Uniform Resource Link (URL) into the internet browser of the electronic device, or opening the platforms native application, or plugin within another application or webpage. A user sends, using an electronic device, a command to a server requesting to view at least one of a plurality of digital cards within a global selection. (STEP A). Once within the webpage, or app, the server will show the goods on the screen of the electronic device. The user will receive, from the server, at least one of the plurality of digital cards contained within the global selection. At least one card within the plurality of digital cards will appear on the screen. (STEP B). The plurality of cards contains metadata and images for a product or piece of content or service that broadly matches a searchable genre in which one is interested. If a user desires to see digital cards that relate to a specific genre, the user may search that particular genre by way of a search query. The user sends, using the electronic device, a command to the server to view at least one of a plurality of digital cards that are contained within a searchable genre. The user will receive, from the server, the at least one of plurality of digital cards contained within the searchable genre. At this point the user may view, using the electronic device, the at least one of a plurality of digital cards contained within the searchable genre. The metadata and images are presented in the center of the screen, portrayed as the middle box in FIG. 2. The screen will display, on the electronic device, at least one of the plurality of digital cards (STEP C). The user then will be viewing, using the electronic device, at least one of the plurality of digital cards on the screen of the electronic device (STEP D).

Referencing FIG. 2, the name of the creator of the item on the individual card is presented as well as information about the content, product, or goods involved in the individual card. This information is displayed by the user tapping, on the screen of the electronic device, the at least one of the plurality of digital cards contained within the global selection to display details regarding the good represented by the digital card. One decides whether or not one would like to save the individual card containing a certain product or other content being viewed by a swipe right or a swipe left by placing a finger on the screen of the electronic device and swiping. If one would rather not save the individual card, one would swipe left on the screen of the electronic device. This is carried out by sending, using the electronic device, a command to the server to remove the at least one digital card on the electronic device screen by swiping left on a screen of the electronic device (STEP E). By swiping left on the screen, it will discard the card from view on the screen. Once at least one of the plurality of digital cards is swiped on, the next digital card will appear and the card swiped upon is removed from the users global selection. The user then receives, from the server, yet another at least one of the plurality of digital cards contained within the global selection (STEP F). To save the individual card, one would swipe right on the screen of the electronic device. In a visual space such as a game engine, one would move the card with a compatible controller to emulate the effect of swiping physically. The user sends, using the electronic device, a command to the server to save the at least one of the plurality of digital cards on the device screen to a curator bucket by swiping right on the screen of the electronic device. (STEP G). One can swipe directly by placing a finger on the screen of the electronic device and swiping. In another embodiment one can use the mouse and swipe on the screen of the electronic device. One can also tap buttons or use voice commands or other actions with one's body to make the software auto-swipe the card. Once the next card shown and is swiped, a new digital card appears. This occurs by receiving, from the server, at least one of the plurality of digital cards contained within the global selection (STEP H). By swiping right on an individual card on the screen of the electronic device, one is saving said card to a bucket. The bucket is the previously mentioned editable saved list. This bucket is the curators bucket. Once a decision has been made about the individual card, another card is presented. One then makes a decision about this other card by either swiping right or swiping left. This process repeats until the bucket is full of saved cards. Once the bucket has been filled, a process called Re-swipe begins. A curator can enter re-swipe at any time, even without a full bucket in order to sort through any number of already saved cards. A curator can request to view their bucket by sending, using the electronic device, a command to the server requesting to view the curator bucket. The user will then receive, from the server, at least one of the plurality of digital cards contained within the curator bucket. Once their bucket is shown, the curator can use the screen of the electronic device to swipe left to remove the card shown, at which point the next digital card will appear. One can swipe right within the curator bucket to save the digital card once again to keep the digital card in the bucket. One can also swipe up on the at least one of a plurality of digital cards on the electronic device screen to purchase it on the spot. When one swipes up, the user will receive, using the electronic device, a prompt to purchase the at least one of the plurality of digital cards by pressing purchase on the screen. Once a card is purchased, from the server, the user will receive a new digital card from the global selection automatically shown on the screen allowing the user to swipe up, swipe left, or swipe right on this digital card. A user will receive, from the server, at least one of the plurality of digital cards contained within the global selection. A bucket can have an infinite size, or a limited size depending on the subscription a user has to the platform. The platform can enable any user to have any bucket size.

In the re-swipe process it will be displayed, on the electronic device, at least one of the plurality of digital cards contained within the curator bucket. The user will then view, using the electronic device, at least one of the plurality of digital cards contained within the curator bucket. The user will then send, using the electronic device, a command to the server to remove the at least one of a plurality of digital cards on the device screen within the curator bucket by swiping left on the screen of the digital device. The user will send, using the electronic device, a command to server to keep the at least one digital card on the device screen in the curator bucket by swiping right on the screen of the digital device. Once the user has completed the re-swipe process, they will view, using the electronic device, the at least one of the plurality of digital cards remaining within the curator bucket. The user can purchase what remains in the curator bucket by sending, using the electronic device, a command to the server to purchase items contained in the curator bucket by pressing a button to complete checkout.

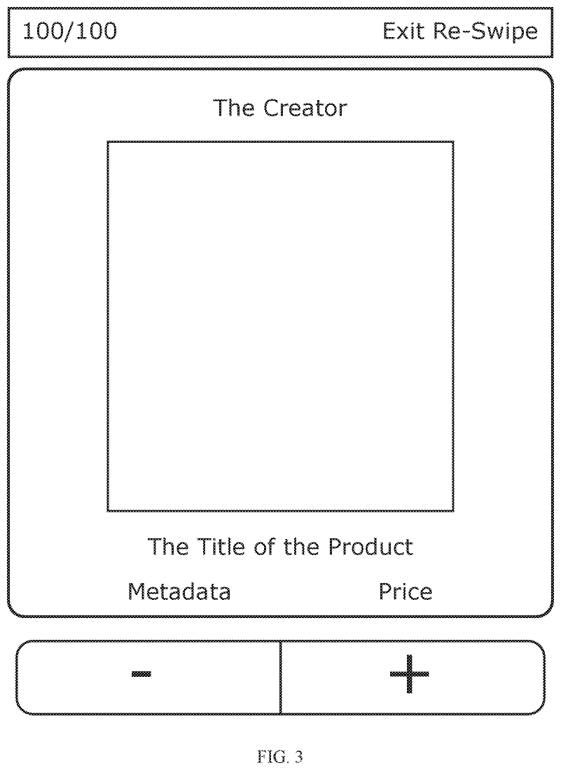

The screen displayed during the Re-swipe process differs from that of the screen displayed during the initial swiping process. The screen displayed during the Re-swipe process is shown in FIG. 3. The same information is displayed during the Re-swipe process, although the screen also includes the number of individual cards currently saved within the bucket. Within the Re-swipe process, one repeats the swipe process on the gathered plurality of cards within the bucket. One decides whether an individual card previously saved is still desirable. By swiping left, the individual card is removed from the bucket. By swiping right, the individual card remains saved in the bucket. The amount of the plurality of cards within the bucket is slimmed down progressively. The Re-swipe process can be repeated until the bucket contains a small enough number of individual cards for a simple decision to be made. The number of times the Re-swipe process is repeated depends on how many individual cards one removes from the bucket during each Re-swipe process. For example, if one hundred individual cards reside within one's bucket and one only swipes left on a single card during a Re-swipe process, one would still have ninety-nine individual cards within the bucket. By only swiping left on one card in each round of the Re-swipe process, one would need to repeat the Re-swipe process over ninety times to result in a single card being left. Alternatively, if one has one hundred individual cards within the bucket and one removes twenty-five individual cards during the initial Re-swipe process, one would then have seventy-five individual cards within the bucket. If one removes twenty-five more individual cards from the bucket during the second Re-swipe process, one would then have fifty individual cards within the bucket. By removing more individual cards during each Re-swipe process, a fewer number of Re-swipe processes are needed to reach a final choice and make a decision with a high-level view of the market. When a curator has filled their bucket fully (i.e a curator with a maximum bucket size of one hundred cards has right swiped on one hundred cards in the initial swipe mode where they discover goods they have not previously swiped on) they will be required to enter Re-swipe to remove cards from the bucket before adding further cards to the bucket from the global selection. The global selection is the complete collection of digital cards. At the same time, the curator is given the option of upgrading the size of their bucket to a larger size that can have more cards saved to it to be re-curated through during the Re-swipe process.

When any one of the plurality of digital cards is displayed on the screen of the electronic device, a user may tap the digital card which will then display all of the details, such as creators name, regarding the good represented by the digital card.

Whenever a curator swipes left on a card from the global selection (when deciding not to add it into their bucket) by default they are also choosing to never see that card again. The same applies in Re-swipe. If a curator swipes left on a card in Re-swipe, by default they will never see it again in any curation mode. However, the platform can enable users to undo the action of swiping left on a card, for any specified period of time, and enable access to previously unwanted cards in another editable list.

In the event of a card representing items that are not yet available for sale, but will be available for sale at some point in the future, saving said cards into a bucket will initiate a notification that will remind the curator of the existence of the items when they become available for purchase. I.e., Curator (Z) swipes right on an item that is scheduled to be available for purchase five days in the future. When the item becomes available for purchase, Curator (Z) is reminded about the item via a notification generated by the server that can be in the application, or in a text, or in an email, or any other form of communication the curator has elected to be contacted with for this purpose. The curator then follows a link to complete the transaction so they can own the item. In the event that a curator removes a card that represents an item with a scheduled future availability date from their bucket during Re-swipe, as the card is removed from the bucket, the system ensures the curator will no longer receive a notification about the availability of said item when it becomes available for purchase in the future.

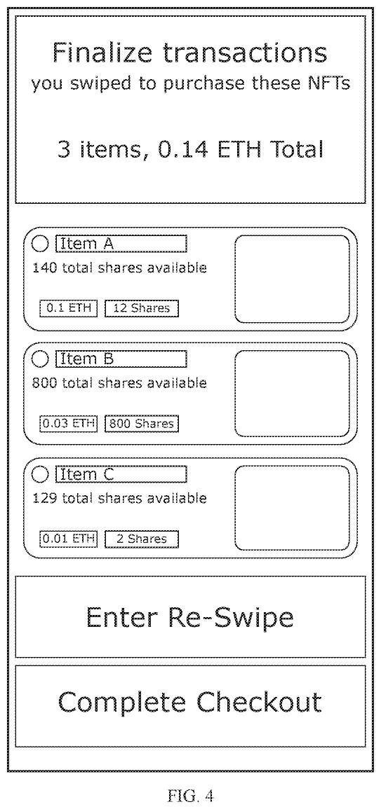

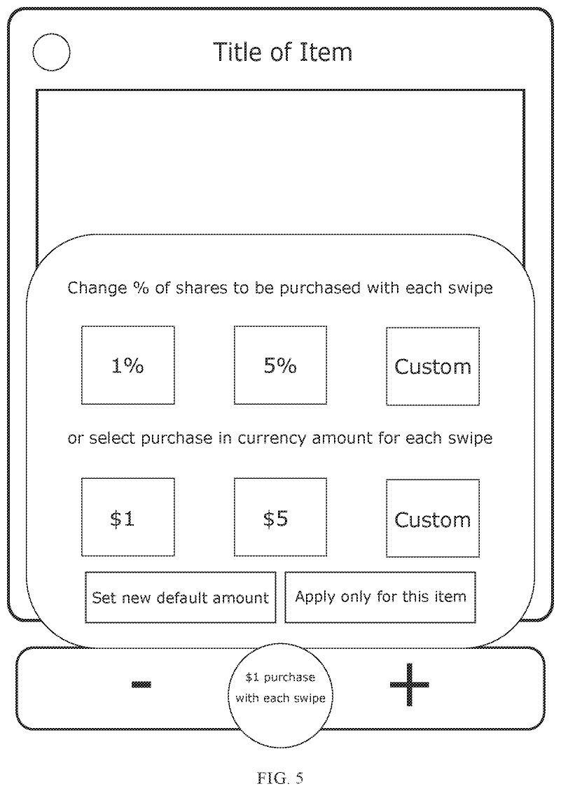

When the cards being sorted through via the present invention showcase goods capable of being purchased, one is able to initiate a financial transaction process when adding those cards to the bucket. In this case, one would follow the process above involving an initial swipe process and the Re-swipe process repeated as many times as necessary. One has then decided that one would like to initiate a financial transaction on the individual cards within the bucket. One then submits a final step completing the financial transaction, shown in FIG. 4, while having a high-level view of what is being purchased. For example, one can add items like artwork from a list into the bucket. One can then sort through the bucket until the items left in the curator bucket are what one would like to purchase. Additionally, one has the option to purchase shares, as shown in FIG. 5, of the item if one would prefer to do so rather than an outright purchase. However, outright purchases are also capable of being done. This process can also apply to a search for services such as a freelancer or products such as a car or a washing machine. This process can also apply to non-fungible tokens (NFTs) that have been displayed on the platform directly from a blockchain or through an API. A curator can save NFTs to their bucket with their right swipe for curation purposes, and if said NFTs are purchasable, they can initiate a financial transaction with a purchase swipe that will initiate the purchase directly on the platform, or the blockchain, or even on another platform that provides the ability to fulfil a transaction via an API. If one chooses the option of purchasing partial ownership, or shares of items, or non-fungible tokens (NFTs) that have been wrapped in fungible tokens, they will be able to set a global “buy” amount for each right swipe. In this instance, one might decide that for every right swipe, one will purchase 1% of the tokens that represent ownership of that item, or even $10 worth of shares in that item, or even 0.0000000001 bitcoin worth of shares in that item. Any currency could be applicable. One may also decide to change the amount of tokens or shares in an item that a right swipe will initiate the purchase of. A button enables them to do that, and one can input or select any number to purchase any % of or number of shares of an item that they wish for that particular purchase swipe. For the next purchase swipe, that number can be changed again and even reverted to a default amount. For example, one can change the number of shares to be purchased by selecting that it affects only the current card, or they can select that it affects the default amount. For selecting that it affects only the current card, the amount will revert to the default amount on the next card. If one selects to change the default amount, a purchase swipe on the next card will also initiate the new default amount for purchasing a % of shares/tokens that represent some degree of ownership of that item.

For a combination of saving items to a list for curative purposes, mixed with a method of purchasing items in the same flow, a right swipe may be selected to save items, and an upward swipe may be selected to purchase items, further streamlining the experience for the curator, as part of the multi-step and modular/customizable nature of the invention.

Before finalization of the transaction, by default, and as a safety measure, one will see a checkout basket where they will confirm that they did intend to purchase those items/goods with their purchase swipe action, and to see that no swipes were made in error. For customization purposes, a curator can elect to forego this final step, and simply initiate and finalize a purchase of an item, NFT, or a fungible token representing some ownership of an NFT, or item, with a purchase swipe.

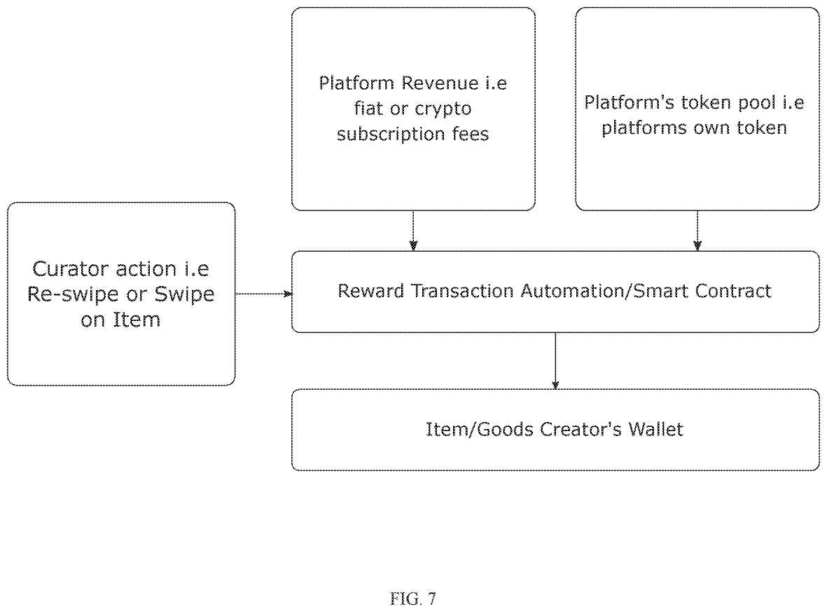

The method for curating content includes a reward system as shown in FIG. 7. On the left of the figure is the curation action, and on top is the subscription revenue and platform token reserve. In between and ensuring the creators get the funds is the smart contract or platform automation code. The reward system provides different levels of token rewards awarded to the creators of the content being curated and sorted through by others. When something produced by a creator is swiped right and placed in one's bucket, the creator is rewarded with a token. If something produced by a creator is swiped up on in the aforementioned swipe-up to purchase method, additional token rewards can also be awarded to the creator of the goods. Varying levels of token rewards can be earned by the creator of an individual card depending on if the card has been swiped right during repeated Re-swipe processes.

If a card representing an NFT has been swiped on with a swipe that would initiate a reward for the creator of the NFT, but the creator is non-native to the platform and their NFTs have been featured on the platform via an API or a connected blockchain, the reward the creator has earned for being curated can be sent to a wallet via the smart contract and be made available for the NFT creator to claim. A smart contract is a self-executing contract with the terms of the agreement between buyer and seller being directly written into lines of code. The smart contract will provide a reward to the wallet of the creator of the good represented by the at least one of the plurality of digital cards when the at least one of a plurality of digital cards containing the creators goods is swiped right on. The smart contract will provide a reward to the wallet of the creator of the goods represented by the at least one of plurality of digital cards when the digital card containing the creators goods is purchased. Alternatively, the token reward can be sent by the smart contract directly to the NFT creator's wallet that minted the NFTs. This means an NFT creator can earn a reward for having their NFTs curated by users on the platform even without needing to sign up to the platform directly. Due to the provenance openly viewable on blockchain linked to NFTs, an NFT creator's verified wallet address that signed the transaction to create their NFTs in the first place can be located, and they can be rewarded for being curated on the platform, without ever visiting the platform, or creating an account.

It is also important to mention that a single card can contain a multitude of items or goods, and even packages of items from multiple different categories that have been curated by the platform or by individual users of the platform. In the event of one of these groups of items being swiped on, the token rewards, and even the purchase costs in the event of a transaction may be split multiple ways between the original creators and the curators of the said stack or group of items.

In relation to the token rewards for creators that occur from a purchase or swipe or Re-swipe of an item, the funding for those token rewards can come from subscription model fees, or other revenue the platform generates, or from a bursary of tokens under the control of the platform, funded by the platform or organization that manages it. These token rewards can be verified with a smart contract, or an internal process, depending on whether the tokens are native to the platform only, or are also crypto tokens existing on the blockchain. In the event that these token rewards come from a smart contract, they will be an automatic process that initiates with an applicable swipe and finalizes when the transaction has been confirmed on the blockchain. As per the smart contract, the tokens will move from the platform's wallet into the wallet of the creator that has earned the reward. All of the token rewards are initiated with the right swipe or right Re-swipe, or other applicable swipe such as an upward swipe by a curator, or purchaser, on the content, items, or goods created by a creator whose content is featured on the platform.

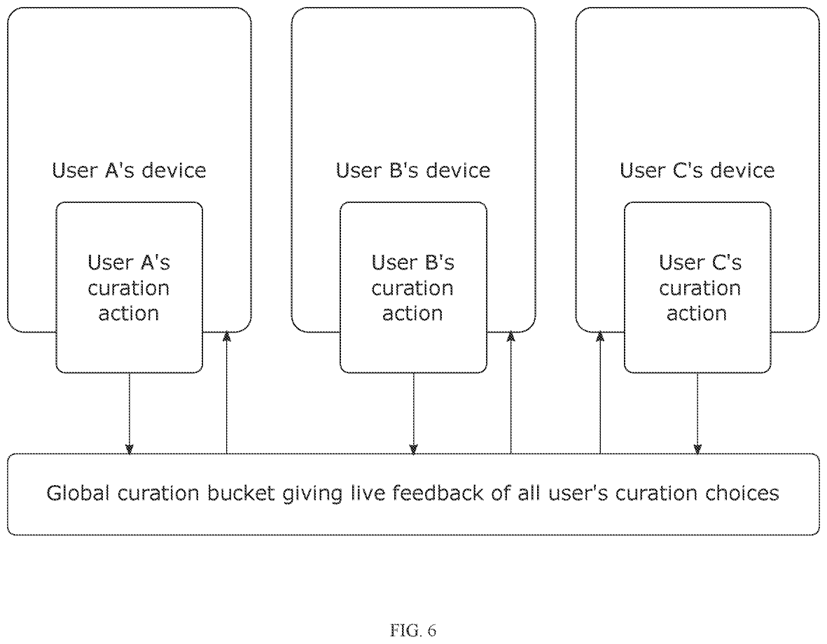

Another feature of the current invention, as shown in FIG. 6, is the ability for users to ‘curate together’, where two or more curation accounts can be linked, and an action on any of the connected accounts will add or remove items to the global bucket in the initial curation phase of swiping and in Re-swipe, so that multiple users can make decisions to curate goods collaboratively. With linked accounts, the response to swipe left or swipe right to the at least one of a plurality of digital cards is reflected amongst all linked users accounts. A swipe up will send, by way of the server, a prompt to any linked account to approve completion of purchase. From a user-experience standpoint, linked curation accounts can also elect to share an audio or video call, or other mode of communication within the application during their curation session. For two or more users to link their accounts, a first user sends a request link to any number of additional user accounts by using an electronic device. Any number of additional users, by way of an electronic device, can either accept the request or deny the request.

Although the invention has been explained in relation to its preferred embodiment, it is to be understood that many other possible modifications and variations can be made without departing from the spirit and scope of the invention.

What is claimed is:

1. A method for curation and transaction, comprising the steps of:
(A) sending, using an electronic device, a command to a server requesting to view at least one of a plurality of digital cards within a global selection;
(B) receiving, from the server, at least one of the plurality of digital cards contained within the global selection;
(C) displaying, on the electronic device, at least one of the plurality of digital cards;
(D) viewing, using the electronic device, at least one of the plurality of digital cards;
(E) sending, using the electronic device, a command to the server to remove the at least one of the plurality of digital cards on the electronic device screen by swiping left on a screen of the electronic device;
(F) receiving, from the server, the at least one of the plurality of digital cards contained within the global selection;
(G) sending, using the electronic device, a command to the server to save the at least one of the plurality of digital cards on the device screen to a curator bucket by swiping right on the screen of the electronic device; and
(H) receiving, from the server, at least one of the plurality of digital cards contained within the global selection.

2. The method for curation and transaction as claimed in claim 1, comprising the steps of:
swiping up on the at least one of a plurality of digital cards on the electronic device screen;
receiving, using the electronic device, a prompt to purchase the at least one of the plurality of digital cards by pressing purchase;
pressing purchase on the electronic device to complete purchase;
receiving, from the server, at least one of the plurality of digital cards contained within the global selection; and
tapping, on the screen of the electronic device, the at least one of the plurality of digital cards contained within the global selection to display details regarding the goods represented by at least one of the plurality of digital cards.

3. The method for curation and transactions as claimed in claim 1, comprising the steps of:
swiping up on the at least one of a plurality of digital cards on the electronic device screen; and
receiving, on the electronic device, a prompt to make an offer to buy the at least one of the plurality of digital cards.

4. The method for curation and transaction as claimed in claim 1, comprising the steps of:
sending, using the electronic device, a command to the server requesting to view the curator bucket; and
receiving, from the server, at least one of the plurality of digital cards contained within the curator bucket.

5. The method for curation and transaction as claimed in claim 4, comprising the steps of:
displaying, on the electronic device, at least one of the plurality of digital cards contained within the curator bucket;
viewing, using the electronic device, at least one of the plurality of digital cards contained within the curator bucket;
sending, using the electronic device, a command to the server to remove the at least one of a plurality of digital cards on the device screen within the curator bucket by swiping left on the screen of the digital device; and
sending, using the electronic device, a command to server to keep the at least one of the plurality of digital cards on the device screen in the curator bucket by swiping right on the screen of the digital device.

6. The method for curation and transaction as claimed in claim 5, comprising the steps of:
viewing, using the electronic device, the at least one of the plurality of digital cards remaining within the curator bucket.

7. The method for curation and transaction as claimed in claim 6, comprising the steps of:
sending, using the electronic device, a command to the server to purchase the at least one of a plurality of digital cards contained in the curator bucket by pressing a button to complete checkout.

8. The method for curation and transaction as claimed in claim 1, comprising the steps of:
sending, using the electronic device, a command to the server to view the at least one of a plurality of digital cards that are contained within a searchable genre;
receiving, from the server, the at least one of plurality of digital cards contained within searchable genre; and
viewing, using the electronic device, the at least one of a plurality of digital cards contained within the searchable genre.

9. The method for curation and transaction as claimed in claim 8, comprising the steps of:
sending, using the electronic device, a command to the server, to purchase the at least one of a plurality of digital cards contained within the searchable genre by swiping up on the screen of the digital device; and
receiving, using the electronic device, a prompt to purchase the at least one of the plurality of digital cards contained within the searchable genre by pressing purchase.

10. The method for curation and transaction as claimed in claim 1, comprising the steps of:
a first user, by way of an electronic device, sending a request to any number of additional users to link accounts; and
any number of additional users, by way of an electronic device, accepting or denying the request to link accounts.

11. The method for curation and transaction as claimed in claim 10, comprising the steps of:
wherein the response to swipe left or swipe right to the at least one of a plurality of digital cards is reflected amongst all linked users accounts; and
wherein a swipe up on the at least one of a plurality of digital cards will send, by way of the server, a prompt to any linked account to approve completion of purchase of the at least one of a plurality of digital cards.

12. The method for curation and transaction as claimed in claim 1, comprising the steps of:
providing, by way of a smart contract, a reward to the wallet of the creator of the goods represented by the at least one of the plurality of digital cards when the at least one of a plurality of digital cards containing the creators goods is swiped right on.

13. The method for curation and transaction as claimed in claim 12
providing, by way of a smart contract, a reward to the wallet of the creator of the goods represented by the at least one of plurality of digital cards when the at least one of the plurality digital card containing the creators goods is purchased.

14. A method for curation and transaction, comprising the steps of:
(A) sending, using an electronic device, a command to a server requesting to view at least one of a plurality of digital cards within a global selection;
(B) receiving, from the server, at least one of the plurality of digital cards contained within the global selection;
(C) displaying, on the electronic device, at least one of the plurality of digital cards;
(D) viewing, using the electronic device, at least one of the plurality of digital cards;
(E) sending, using the electronic device, a command to the server to remove the at least one of the plurality of digital cards on the electronic device screen by swiping left on a screen of the electronic device;
(F) receiving, from the server, at least one of the plurality of digital cards contained within the global selection;
(G) sending, using the electronic device, a command to the server to save the at least one of the plurality of digital cards on the device screen to a curator bucket by swiping right on the screen of the electronic device;
(H) receiving, from the server, at least one of the plurality of digital cards contained within the global selection;
(I) swiping up on the at least one of a plurality of digital cards on the electronic device screen; and
(J) receiving, using the electronic device, a prompt to purchase the at least one of the plurality of digital cards by pressing purchase.

15. The method for curation and transaction as claimed in claim 14, comprising the steps of:
pressing purchase on the electronic device to complete purchase;
receiving, from the server, at least one of the plurality of digital cards contained within the global selection;
tapping, on the screen of the electronic device, the at least one of the plurality of digital cards contained within the global selection to display details regarding the goods represented by at least one of the plurality of digital cards;
swiping up on the at least one of the plurality of digital cards on the electronic device screen; and
receiving, on the electronic device, a prompt to make an offer or to buy the at least one of the plurality of digital cards.

16. The method for curation and transaction as claimed in claim 14, comprising the steps of:
sending, using the electronic device, a command to the server requesting to view the curator bucket;
receiving, from the server, at least one of the plurality of digital cards contained within the curator bucket;
displaying, on the electronic device, at least one of the plurality of digital cards contained within the curator bucket;
viewing, using the electronic device, at least one of the plurality of digital cards contained within the curator bucket;
sending, using the electronic device, a command to the server to remove the at least one of the plurality of digital cards on the device screen within the curator bucket by swiping left on the screen of the digital device;
sending, using the electronic device, a command to server to keep the at least one of the plurality of digital cards on the device screen in the curator bucket by swiping right on the screen of the digital device.

17. The method for curation and transaction as claimed in claim 16 by comprising the steps of:
viewing, using the electronic device, the at least one of the plurality of digital cards remaining within the curator bucket;
sending, using the electronic device, a command to the server to purchase the at least one of the plurality of digital cards contained in the curator bucket by pressing a button to complete checkout.

18. The method for curation and transaction as claimed in claim 14, comprising the steps of:
sending, using the electronic device, a command to the server to view the at least one of a plurality digital cards that are contained within a searchable genre;
receiving, from the server, the at least one of a plurality of digital cards contained within the searchable genre;
viewing, using the electronic device, the at least one a plurality of digital cards contained within the searchable genre;
sending, using the electronic device, a command to the server, to purchase the at least one of a plurality of digital cards contained within the searchable genre by swiping up on the screen of the digital device; and
receiving, using the electronic device, a prompt to purchase the at least one of the plurality of digital cards contained within the searchable genre by pressing purchase.

19. The method for curation and transaction as claimed in claim 14, comprising the steps of:
a first user, by way of an electronic device, sending a request to any number of additional users to link accounts;
any number of additional users, by way of an electronic device, accepting or denying the request to link accounts;
wherein the response to swipe left or swipe right to the at least one digital card is reflected amongst all linked users accounts; and
wherein a swipe up on the at least one of a plurality of digital cards will send, by way of the server, a prompt to any linked account to approve completion of purchase.

20. The method for curation and transaction as claimed in claim 14, comprising the steps of:
providing, by way of a smart contract, a reward to the wallet of the creator of the goods represented by the at least one of the plurality of digital cards when the at least one of a plurality of digital cards containing the creators goods is swiped right on; and
providing, by way of a smart contract, a reward to the wallet of the creator of goods represented by the at least one of plurality of digital cards when the at least one a plurality of digital cards containing the creators goods is purchased.
